(19) United States
(12) Patent Application Publication
(10) Pub. No.: US 2009/0063706 A1
(43) Pub. Date: Mar. 5, 2009

(54) Combined Layer 2 Virtual MAC Address with Layer 3 IP Address Routing

(75) Inventors: Joel Goldman, Port Ewen, NY (US); Jeffrey Douglas Haggar, Holly Springs, NC (US); Hugh Edward Hockett, Raleigh, NC (US); Maurice Isrel, Raleigh, NC (US); Bruce H. Ratcliff, Red Hook, NY (US); Jerry Wayne Stevens, Raleigh, NC (US); Stephen Roger Valley, Valatie, NY (US)

Correspondence Address: STEVENS & SHOWALTER, L.L.P., BOX IBM, 7019 CORPORATE WAY, DAYTON, OH, 45459-4238, US

(73) Assignee: INTERNATIONAL BUSINESS MACHINES CORPORATION, Armonk, NY (US)

(21) Appl. No.: 11/847,903

(22) Filed: Aug. 30, 2007

(51) Int. Cl. G06F 15/16

(52) U.S. Cl. 709/250

(57) ABSTRACT

Inbound packets received by a physical network adapter of a processing device are routed by evaluating an inbound frame to determine if an inbound frame destination MAC address is associated with the processing device and determining whether the inbound frame should be routed to a corresponding logical interface or to drop the inbound frame if the inbound frame destination MAC address is equal to a virtual MAC address supported by the processing device. If it is determined that the inbound frame should be routed to the corresponding logical interface, then any necessary layer 3 functions are performed and the inbound frame is routed to the corresponding logical interface, thereby combining both layer 2 and layer 3 routing into a single logical function.

### BACKGROUND OF THE INVENTION

The present invention relates to systems, computer-implemented methods and computer program products for combining layer 2 virtual MAC address information with layer 3 IP address routing information.

Certain server systems may be partitioned so as to allow multiple operating system images or “virtual servers” to share the same hardware input/output adapter, e.g., a network adapter which has a single physical port and a single Media Access Control (MAC) address. Under this arrangement, each virtual server utilizes a communication protocol stack that employs a “layer 3” (Internet Protocol address) routing function with the network adapter. While the sharing and virtualization techniques used to create these virtual servers present an efficient use of hardware resources, it may also create various challenges for external switches and routers that communicate with one or more of the virtual servers.

As an example, a given server system may support multiple communication protocol stacks and their associated resources (applications) that are all capable of communication with external network devices using the same physical MAC address of a corresponding network adapter, which may lead to “overloading” of the physical MAC address. Moreover, the use of multiple communication protocol stacks sharing a physical MAC address may disrupt several known MAC address routing protocols, such as the address resolution protocol (ARP), which matches target IP addresses to MAC addresses. In this regard, the ARP protocol may be disrupted because duplicate applications that are executing on different virtual servers are reached from external sources by the same MAC address.

Multiple protocol stacks which share the same physical MAC address may also create a variety of configuration, routing and usability issues. In such an environment, external network devices such as load balancers, switches and/or routers may need to direct traffic to a specific instance of an application on a corresponding virtual server. Accordingly, networking protocols such as network address translation (NAT) and generic routing encapsulation (GRE) tunneling must be utilized to achieve the proper load balancing. However, the introduction of NAT and GRE introduce yet another set of compatibility issues within the network environment.

### BRIEF SUMMARY OF THE INVENTION

According to aspects of the present invention, inbound packets received by a physical network adapter of a processing device are routed by evaluating an inbound frame to determine if an inbound frame destination MAC address is associated with the processing device. A determination is made as to whether the inbound frame should be routed to a corresponding logical interface or to drop the inbound frame if the inbound frame destination MAC address is equal to a virtual MAC address supported by the processing device. If it is determined that the inbound frame should be routed to the corresponding logical interface, then any necessary layer 3 functions are performed and the inbound frame is routed to the corresponding logical interface, thereby combining both layer 2 and layer 3 routing into a single logical function.

### BRIEF DESCRIPTION OF THE SEVERAL VIEWS OF THE DRAWINGS

FIG. 1 is a schematic illustration of an exemplary system in which a server system may combine layer 2 virtual MAC addresses with layer 3 IP address routing according to various aspects of the present invention;

FIG. 2 is a block diagram of a server system that supports virtual servers that may combine layer 2 virtual MAC addresses with layer 3 IP address routing according to various aspects of the present invention;

FIG. 3 is a block diagram of a system that includes multiple logical partitions and a single physical hardware layer;

FIG. 4 is a flow chart illustrating a method of associating a layer 3 virtual MAC address according to various aspects of the present invention;

FIG. 5 is a flow chart illustrating a method of implementing layer 2 virtual MAC addresses with layer 3 IP address routing according to various aspects of the present invention; and

FIG. 6 is a block diagram of an exemplary computer system including a computer usable medium having computer usable program code embodied therewith, where the exemplary computer system is capable of executing a computer program product to combine layer 2 virtual MAC addresses with layer 3 IP address routing according to various aspects of the present invention.

### DETAILED DESCRIPTION OF THE INVENTION

According to various aspects of the present invention, a host processing device comprises multiple logical interfaces that share a common network adapter. For example, multiple operating system instances or virtual servers may each utilize one or more communication protocol stacks that employ a “layer 3” Internet Protocol (IP) address routing function with the network adapter. Additionally, a unique virtual MAC address is created for each logical interface with the network adapter while preserving the layer 3 mode functionality present with the network adapter, thereby combining a virtual MAC address with existing layer 3 routing conventions. Under this configuration, external network devices such as switches and routers see a unique virtual MAC address for each communication protocol stack. This creates the appearance of each operating system instance using a unique physical adapter.

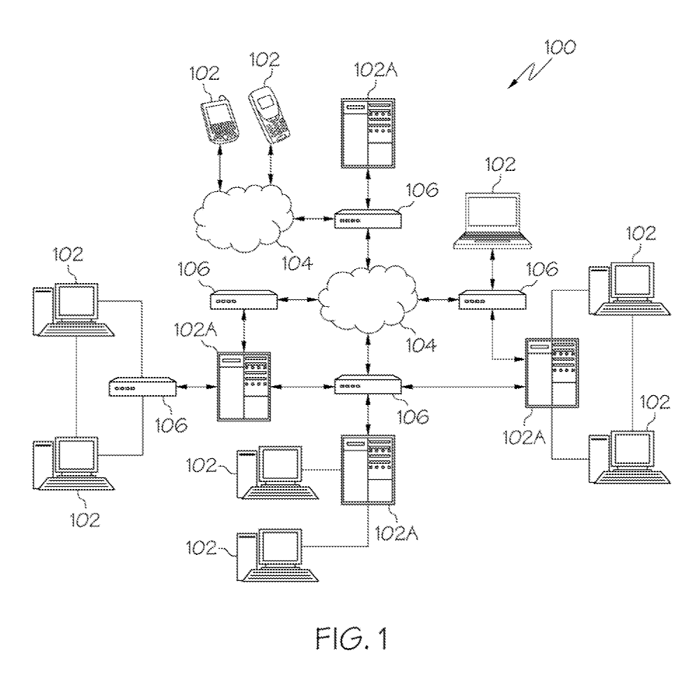

Referring now to the drawings and particularly to FIG. 1, a general diagram of an exemplary enterprise 100 is illustrated. The enterprise 100 comprises a plurality hardware and/or software processing devices, designated in general by the reference numeral 102, that are linked together by a network 104. Typical processing devices 102 may include servers, personal computers, notebook computers, transactional systems, appliance or pervasive computing devices such as a personal data assistant (PDA), palm computers, cellular access processing devices, special purpose computing devices, printing and imaging devices, facsimile devices, storage devices and/or other devices capable of communicating over the network 104. The processing devices 102 may also comprise software, including applications and servers that interact with various databases, spreadsheets, structured documents, unstructured documents and/or other files containing information.

The network 104 provides communications links between the various processing devices 102, and may be supported by networking components 106 that interconnect the processing devices 102, including for example, routers, switches, hubs, firewalls, network interfaces wired or wireless communications links and corresponding interconnections. Moreover, the network 104 may comprise connections using one or more intranets, extranets, local area networks (LAN), wide area networks (WAN), wireless networks (WIFI), the internet, including the world wide web, and/or other arrangements for enabling communication between the processing devices 102, in either real time or otherwise, e.g., via time shifting, batch processing, etc. The depicted example is not meant to imply architectural limitations with respect to the present invention. Moreover, the above configuration is shown by way of illustration and not by way of limitation. As such, other processing system configurations may be implemented.

In the exemplary environment 100, one or more of the processing devices 102, which are further designated by the reference numeral 102A, may support one or more physical network adapters (not shown). Each network adapter may be shared by multiple logical partitions where each logical partition comprises an allocation of the host processing device's processor(s), memory, storage and/or other features into a plurality of sets of resources capable or executing their own operating system instance and corresponding applications. As an example, one or more of the processing devices 102A may comprise a zSeries mainframe by International Business Machines (IBM) of Armonk, N.Y.

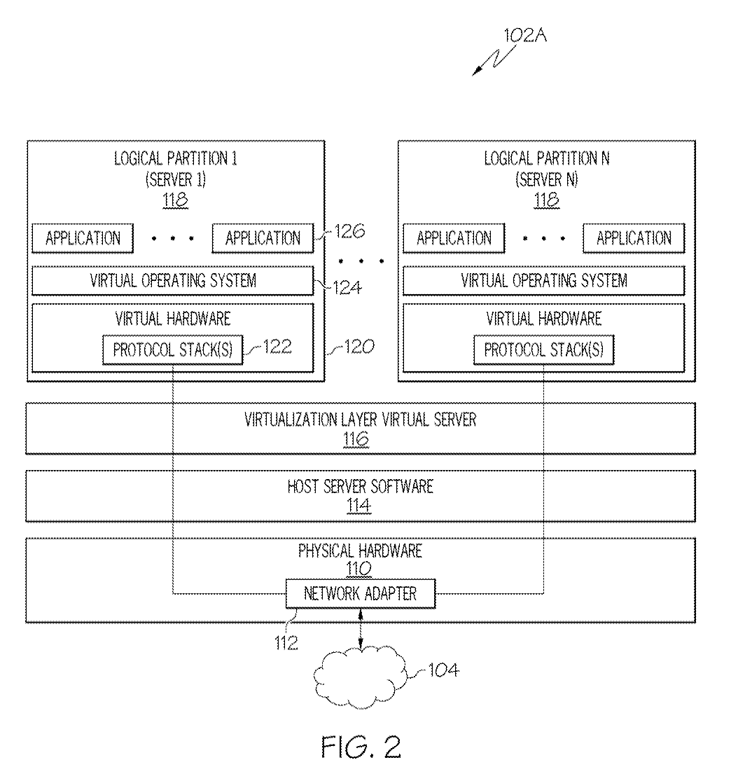

With reference to FIG. 2, an illustrative processing device 102A comprises physical hardware 110, which includes at least one physical network adapter 112 for communicating across the network 104, host server software 114 and may further include a virtualization layer virtual server layer 116 that enables the processing device 102A to support multiple logical partitions 118, e.g., virtual machines. Each logical partition 118 in general, looks and behaves like a server in the illustrative example, and includes a virtual hardware layer 120 that includes at least one communication protocol stack 122, e.g., an IP stack, a virtual operating system layer 124 for executing an appropriate operating system and one or more applications 126. In general, an application 126 executing in a logical partition 118, e.g., a virtual server, uses a corresponding communication protocol stack 122, e.g., an IP stack to communicate with other network devices. To enable communication with network processing devices 102 that are external to the processing device 102A, the communication protocol stack 122 employs a (layer 3) IP address routing function with the physical network adapter 112.

The network adapter 112 of the processing device 102A may comprise, for example, an OSA-Express adapter by IBM, which can be shared by multiple logical partitions. A physical OSA port that is configured as a Channel Path identifier (CHPID) can also be shared by logical partitions which are in different Logical Channel Subsystems (LCSS). In other words, OSD CHPIDs support LCSS spanning. In this particular exemplary network adapter 112, sharing is provided by the zSeries mainframe input/output (I/O) architecture along with dynamic logical partitioning (LPAR) (hypervisor) and the zSeries Extended Multiple Image Facility (EMIF) support.

According to various aspects of the present invention, physical port sharing of the network adapter 112 among the various logical interfaces, such as protocol stacks 122, is enabled on the processing device 102A. However, the physical port MAC address associated with the network adapter 112 is not shared by the various communication protocol stacks 122 on the processing device 102A. For example, each communication protocol stack 122 associated with the logical partitions 118 on the processing device 102A utilize their own unique logical (virtual) MAC address and also utilize the common shared physical port of the network adapter 112 for communication with external devices across the network 104.

According to aspects of the present invention, the network adapter 112 provides layer 3 offloaded functions and also allows for the ability to exploit “Layer 3 virtual” MAC addresses. Thus, shortcomings in conventional capabilities that only allow virtual MAC addresses in Layer 2 or other protocol agnostic modes are avoided. Moreover, the use of a virtual MAC address with a corresponding logical interface enables external processing devices 102 and networking components 106 such as switches and routers and load balancers to properly resolve IP addresses of virtual servers to a single and unique MAC address, thereby achieving efficient load-balancing.

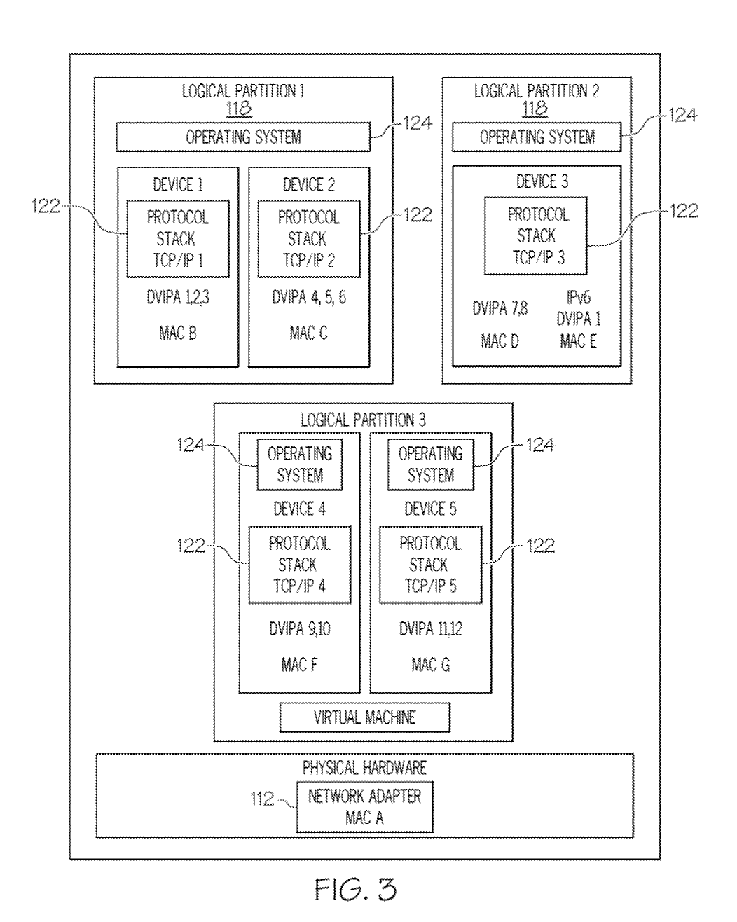

Referring to FIG. 3, three exemplary logical partitions 118 of the processing device 102A of FIG. 2 are illustrated to show the provision of virtual MAC addresses for logical interfaces to the network adapter 112. As shown, the network adapter 112 in the physical hardware layer has a MAC address of “MAC A”. Logical Partition 1 includes two devices that utilize their own protocol stacks 122 to communicate with other processing devices 102. As shown, Device 1 communicates via a protocol stack 122 designated as “TCP/IP 1”, which has dynamic virtual IP addresses of 1, 2, 3 (IPv4) and a virtual MAC address of “MAC B”. Similarly, Device 2 communicates via a protocol stack 122 designated as “TCP/IP 2”, which has dynamic virtual IP addresses 4, 5, 6 (IPv4) and a virtual MAC address of “MAC C”.

Logical Partition 2 includes a device designated as Device 3 that communicates via a protocol stack 122 designated as “TCP/IP 3”. TCP/IP 3 has dynamic virtual IP addresses of 7, 8 (IPv4) and a virtual MAC address of “MAC D”. TCP/IP 3 is also capable of IPv6 communication at dynamic virtual IP address 1 and MAC address “MAC E”.

Logical Partition 3 implements a virtual machine that includes two devices that utilize their own protocol stacks 122 to communicate with other processing devices 102. Device 4 communicates via a protocol stack 122 designated as “TCP/IP 4”, which has dynamic virtual IP addresses of 9, 10 (IPv4) and a virtual MAC address of “MAC F”. Similarly, Device 5 communicates via a protocol stack 122 designated as “TCP/IP 5”, which has dynamic virtual IP addresses 11, 12 (IPv4) and a virtual MAC address of “MAC G”.

According to various aspects of the present invention, all IP layer 3 functions provided by the network adapter 112 are maintained. For example, the layer 3 functions offloaded to the network adapter 112 represent significant performance benefits such as central processing unit (CPU) processing savings. Additionally, the processing device 102A can exploit a layer 3 virtual MAC addressing. Layer 3 virtual MAC functionality may be provided by hardware support and/or software exploitation. For example, the network adapter 112 may be required to add or otherwise implement a function that combines/blends the layer 3 support provided by the particular data transfer architecture with virtual MAC support, i.e. the ability to exploit virtual MAC addressing while in L3 mode.

As an illustrative example, the above described OSA-Express hardware adapter uses a Queued Direct Input/Output (QDIO) data transfer architecture. The current QDIO layer 3 support and all associated L3 (IPA) functions may be provided to accommodate virtual MAC support, i.e., the ability to exploit virtual MAC addressing while in L3 mode. Under this arrangement, a virtual MAC may be allowed, for example, per protocol (IPv4 or IPv6) per stack (QDIO data device).

Additionally, software may be modified to exploit the hardware support for layer 3 virtual MAC addressability. For example, an operating system such as z/OS CommServer by IBM, which may be utilized to implement the logical partitions 118, may add software to exploit the new hardware support, i.e., layer 3 virtual MAC addressing. As an example, when required or applicable to a particular circumstance, an operating system user may configure one or more virtual MAC addresses, such as on Link and Interface statements. TCP/IP would then register and de-register the virtual MAC addresses, e.g., in a manner analogous to how TCP/IP deals with VLAN IDs. As such, from an external perspective, all IP addresses for a given protocol stack are now reachable by its own virtual MAC address.

In an illustrative implementation, support may be provided for a virtual MAC address per VLAN ID, supporting multiple VLAN IDs per physical MAC or adapter. In this regard, each logical interface that is also a separate logical device (as seen by the host OS) could consist of a unique Virtual MAC, VLAN ID, layer 3 IPv4 or IPv6 address, etc. Thus, in this example, each unique logical interface could consist of the attributes including a VMAC, VLAN ID and IP Address.

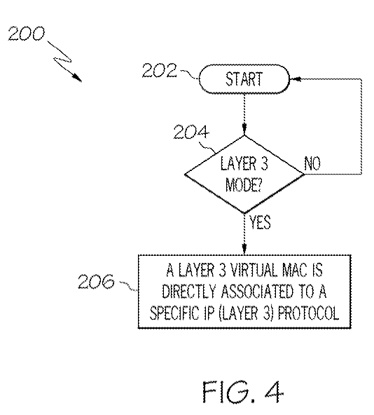

Referring to FIG. 4, a method 200 of providing layer 3 virtual MAC support is illustrated. The method starts at 202 and a decision is made at 204 as to whether virtual MAC support is being exploited for layer 3 mode, e.g., QDIO layer 3 mode in the exemplary OSA Express adapter described in greater detail herein, where the layer 3 mode functionality is not related to the QDIO layer 2 support. If virtual MAC support is not being exploited for layer 3 mode, then flow returns back to the start at 202. If layer 3 virtual MAC address is to be exploited in layer 3 mode, a layer 3 virtual MAC address is associated to a specific IP (Layer 3) protocol at 206. A virtual MAC address can be assigned to each valid IP protocol, i.e. one virtual MAC address for Internet Protocol version 4 (IPv4) and one virtual MAC address for Internet Protocol version 6 (IPv6).

According to various aspects of the preset invention, a signaling mechanism or primitive may be provided, which allows each protocol stack 122 to request a virtual MAC address from the physical network adapter 112. Alternatively, the protocol stacks 122 may be assigned a specific virtual MAC address during an activation process. Accordingly, the physical network adapter 112 will associate the assigned virtual MAC addresses with the host connection and externalize the MAC addresses to the external processing devices 102 across the network 104, e.g., during all corresponding frame building and or processing and communications with the resources on the network 104. Processing devices 106, such as routers and switches on the network 104 will thus eventually discover the virtual MAC addresses of the protocol stacks 122 and associate all IP addresses with the virtual MAC addresses such as during ARP processing. This provides the appearance as if each logical host connection to the OSA is actually using a dedicated or unique OSA network adapter 112.

Each operating system that implements the function of combining layer 3 mode with a virtual MAC address may be required to provide any necessary externals required for the system configuration of the virtual MAC along with any necessary system controls or system display information within their operating environment.

An Exemplary Layer 3 Virtual MAC Implementation:

As noted in greater detail above with reference to FIGS. 2 and 3, a layer 3 virtual MAC address can be assigned to each valid protocol stack, e.g., one virtual MAC address for IPv4 and one virtual MAC address for IPv6. Each IP protocol interface is enabled and disabled with an IP assist primitive, such as SetAssistParms. IPv4 uses ARP (Start Assist) and IPv6 uses IPv6 (Start Assist). Assigning a virtual MAC address may become closely associated with this protocol activation processing (logically equivalent in sequence).

Virtual MAC addresses may be limited to a maximum of one virtual MAC address per logical interface, i.e., one virtual MAC address per IP protocol per QDIO data device. Moreover, in certain implementations, restrictions in layer 3 virtual MAC support may be implemented. As an example, if the processing device is an IBM zSeries server that utilizes, QDIO, then layer 3 virtual MAC support may be exploited only in QDIO layer 3 mode, which is unrelated to QDIO layer 2 support as noted above.

Conceptually, when a layer 3 virtual MAC address is assigned, the network adapter port is then “logically dedicated” to a single stack, thus the stack is not sharing the virtual MAC address logical port with any other stack. As such, many stack sharing issues are eliminated, e.g., because all traffic destined to this virtual MAC address can only go to one and only one stack.

When a layer 3 virtual MAC address is allocated to a protocol stack 122, all current IP assist functions provided by the network adapter 112, e.g., network adapter functions including registering all IP addresses, may still be applicable and remain unchanged. An exemplary exception is the use of a primary router (Pri Router) function in OSA, which is described in greater detail herein with reference to inbound routing.

Any suitable technique may be utilized to derive each virtual MAC address. For example, virtual MAC address usage, configuration, and assignment coordination may be “user-defined”, e.g., left to the responsibility of the user of the corresponding processing device 102A, such as the system administrator. Under this arrangement, the user may be responsible for assuring uniqueness. Alternatively, attempts to assign duplicate MAC addresses within a processing device 102A may be validated (policed) and rejected. A rejected assignment may result in an activation failure for the host interface requiring appropriate corrective action. Exposure to duplication of virtual MAC addresses within a processing device 102A can be minimized by automatically generating the virtual MAC addresses, e.g., by allowing the network adapter 112 to control address usage, configuration and assignment coordination of virtual MAC addresses.

Moreover, virtual MAC addresses may be static or dynamically assigned. Additionally, virtual MAC addresses may be “re-used”, such as for device recovery scenarios. In this regard, some switches may cache an IP address to MAC address relationship for period of time. Thus, a protocol stack such as the Z/OS stack, may re-use the previous network adapter generated virtual MAC address during recovery scenarios e.g., during a stop/start sequence.

Regardless of how the virtual MAC address is generated, all layer 3 virtual MAC addresses should be a local administered address, which may be enforced, for example, by the network adapter 112, by the operating system, system administrator, etc. Also, where layer 3 virtual MAC addressability is not required, multiple protocol stacks 122 may be allowed to use the hardware MAC address of the network adapter 112, e.g., “MAC A”.

According to an aspect of the present invention, inbound routing rules utilized by the network adapter 112 may be slightly different when a layer 3 virtual MAC address is assigned. For example, only packets with a destination MAC address matching the layer 3 virtual MAC address will be passed to the corresponding stack. However, VLAN IDs (and priority tagging) and VLAN exploitation and deployment (network topology) may not be affected by layer 3 virtual MAC address and the processing remains unchanged. Similarly, IP address takeover and giveback may not be affected by the use of a layer 3 virtual MAC address, i.e., VIPA addresses which are on the same LAN and VLAN can be moved from and to various IP stacks with and without layer 3 virtual MACs.

Virtual MAC Address Format Specifications and Reuse:

Where the network adapter 112 generates virtual MAC addresses, an exemplary exploitation scheme may set the x′02′ bit in byte zero (the first byte) to ON, indicating local administered MAC address. The next two bytes may be used as a use count for all layer 3 virtual MAC addresses generated, for example, by OSA for the entire CHPID. The last 3 bytes may be copied from the manufacture's hardware MAC address. This approach will assure that a unique MAC address is generated for each activation sequence.

The use count within the OSA generated virtual MAC address allows a stack to reuse a previously generated virtual MAC address upon immediate re-activation, such as for device recovery, e.g., as long as the use count has not wrapped and the previously used virtual MAC address has not been reassigned.

When a layer 3 virtual MAC address is assigned and is in effect for a given IPv4 or IPv6 logical interface, the network adapter 112 should always use the virtual MAC address instead of the real hardware MAC address for all processing associated with the corresponding protocol stack. For example, when creating outbound frames, the network adapter 112 should use the virtual MAC address as the source MAC address for all frames associated with the IP stack interface. The network adapter 112 may use the virtual MAC address for all IPv4 ARP processing performed on behalf of the TCP/IP (IPv4) stack. Additionally, the network adapter 112 may return the virtual MAC address inbound to the host operating system in all assist primitives in which the virtual MAC address is currently included, including for example, the Query ARP Cache Reply-Home address for IPv4 and CREATADDR reply within the Interface ID for IPv6.

Layer 3 Virtual MAC Address and Layer 3 Routing

In certain circumstances, a system administrator may want to enable layer 3 virtual MAC address routing, and in other configurations, e.g., for security reasons, the system administrator may not want to allow layer 3 virtual MAC addressing. Therefore, the layer 3 virtual MAC address function may support two modes of operation, which are designated herein with as a “router” mode” and a “non-router mode” of operation.

For inbound packets with a destination MAC address equal to a layer 3 virtual MAC address and layer 3 in “non-router mode”, only packets with valid VLAN IDs and destination IP addresses which have been previously registered, e.g., via Set IPA or SetIPM by the stack using this layer 3 virtual MAC address are routed to this stack. Thus, all inbound destination IP addresses must be registered with network adapter 112.

For inbound packets with a destination MAC address equal to a layer 3 virtual MAC address, in “router mode”, all packets with a valid VLAN ID (if applicable) with a destination MAC matching the layer 3 virtual MAC address are routed to this stack without regards to the destination IP address. In other words, the IP address need not be evaluated.

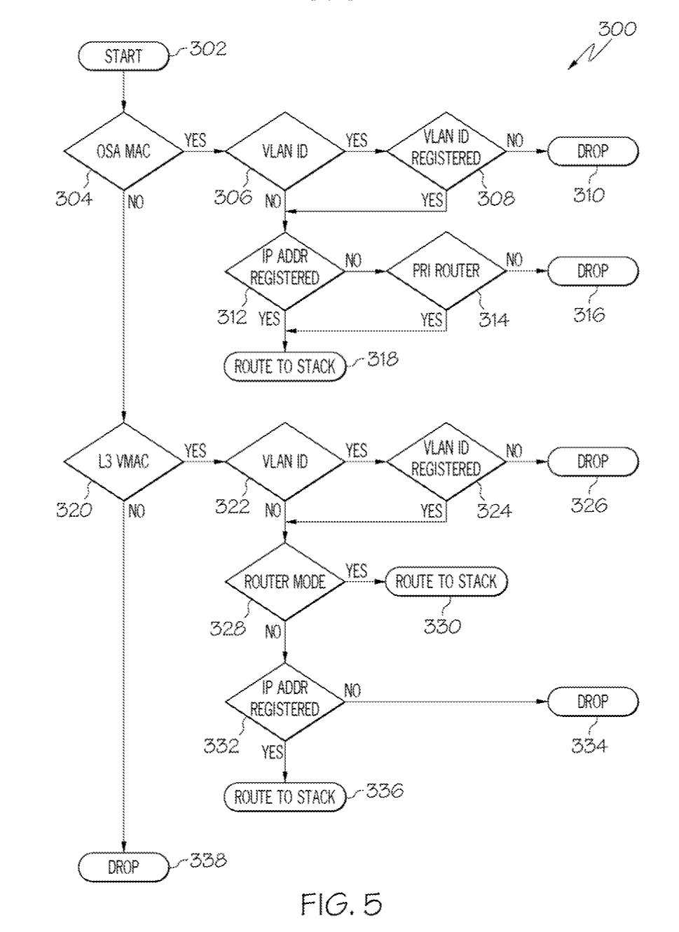

Referring to FIG. 5, a flow chart 300 describes an exemplary method of performing inbound routing for layer 3 virtual MAC addressing. The method starts at 302 and initially determines whether the destination MAC address of the inbound frame is associated with the corresponding processing device. For example, the destination MAC address in the inbound frame may either be associated with the MAC address of the physical adapter or a virtual MAC address.

The destination MAC address within the inbound frame is evaluated at 304 to determine if the inbound frame destination MAC address is equal to the physical network adapter MAC address. If the inbound frame destination MAC address is the same as the physical network adapter MAC address, then hardware MAC address processing is utilized to perform traditional layer 3 inbound routing processing. Accordingly, a check is made to determine if the inbound frame contains a virtual local area network identification (VLAN ID) at 306. If yes, then a check is made to determine if the VLAN ID is registered to the instant stack at 308. If the VLAN ID is not registered to the instant stack, then the frame is dropped at 310.

Certain adapters allow the user to configure one IP stack as a primary “router” stack, designated herein as Pri Router, which allows the adapter to route packets destined to a specific IP stack when the destination IP address has not been registered with the adapter. Under such a configuration, if the inbound frame does not contain a VLAN ID at 306 or if the VLAN ID is registered at 308, then a check is made as to whether the destination IP address within the inbound frame is registered by the instant stack. If the destination IP address is not registered by the instant stack, a check is made as to whether the instant stack is the Pri Router at 314.

If the instant stack is not the Pri Router stack, then the inbound frame is dropped at 316. If the destination IP address is registered by the instant stack at 312 or if the instant stack is the Pri Router at 314, then any necessary inbound layer 3 functions, e.g. checksum, etc. are performed and the frame is routed to the instant stack at 318.

If the inbound frame destination MAC address is not equal to the physical network adapter MAC address at 304, then a check is made to determine if the inbound frame destination MAC address is equal to a layer 3, virtual MAC address at 320. If the inbound frame destination MAC address is equal to the virtual MAC address, then a determination is made as to whether the inbound frame should be routed to a corresponding logical interface or whether the inbound frame should be dropped.

If the inbound frame destination MAC address is a layer 3 virtual MAC address, then a check is made at 322 to determine if the inbound frame contains a VLAN ID. If the inbound frame contains a VLAN ID, then a check is made at 324 to determine if the VLAN ID is registered to the instant stack at 324. If the VLAN ID is not registered to the instant stack, then the inbound frame is dropped at 326.

If the inbound frame does not contain a VLAN ID at 322 or if the VLAN ID is registered to the instant stack at 324, then a check is made to determine if the interface connection is operating in router mode at 328. If the interface connection is operating in router mode, then any necessary inbound layer 3 functions, e.g. checksum, etc. are performed and the inbound frame is routed to the instant stack at 330.

If the interface connection is not operating in router mode, then the interface connection is operating in non-router mode. In this regard, there is no Pri Router mode for layer 3 virtual MAC addressing. As such, a check is made to determine if the destination IP address in the inbound frame is registered to the instant stack at 332. If the destination IP Address is not registered to the instant stack, then the inbound frame is dropped at 334. If the destination IP Address is registered to the instant stack, then any necessary inbound layer 3 functions, e.g. checksum, etc. are performed and the inbound frame is routed to the instant stack at 336. If the inbound frame destination MAC address is not equal to a layer 3, virtual MAC address at 320, then the frame is dropped at 338.

Thus, when a stack is using a virtual MAC address, it cannot receive any frames that are sent to the hardware MAC address.

Given that layer 3 virtual MAC addresses are directly related to a specific layer 3 protocol, e.g., IPv4 or IPv6, the registration may be accomplished using the existing primitive which is used to control the various IP assist functions, such as the Set Assist Parameters. As such a new SetAsstParms option, which is referred to herein as “Assign Virtual MAC” (AssgnVMAC) may be created. This function is not related to Set Virtual MAC or other virtual MAC address features that are used for layer 2 support.

The new SetAsstParms option “Assign Virtual MAC may be controlled just like any other option using Start and Stop Assist subcommands. However, unlike many of the other IP assist options, this option is very fundamental to each individual IP (IPv4 or IPv6) interface. According to an exemplary implementation, this aspect causes the layer 3 virtual MAC address function to be become static in nature (relative to each interface). For an active interface the virtual MAC address is either “permanently” assigned or never assigned. However, the layer 3 virtual MAC address can not dynamically change for an active interface. Alternative rules and policies may alternatively be implemented.

In an exemplary implementation, the AssgnVMAC option is subjected to the following rules which are applicable to both IPv4 and IPv6:

Assignment—If a layer 3 virtual MAC address is going to be used for a given interface, it may be assigned “early” in the interface activation sequence. Specifically, the AssgnVMAC option may be issued prior to any attempt to register an IP address (SetIPA or SetIPM). The AssgnVMAC with the Start Assist subcommand is valid until the first SetIPA (or SetIPM) is issued. Once the first SetIPA or SetIPM is attempted (successfully or unsuccessfully issued) the AssignVMAC is no longer a valid option, and may be rejected by the adapter. Ideally, the stack should assign the virtual MAC address immediately after enabling each IP protocol interface, e.g., Start Assist for ARP (IPv4) and Start Assist (IPv6). Each time a protocol interface (IPv4 or IPv6) is started or re-started, the virtual MAC address may further be reestablished or otherwise assigned.

Deletion—The layer 3 virtual MAC address may be considered a “permanent” attribute of an active IP interface. Under this configuration, it is not an attribute (assist option) that can be dynamically added and removed from an active interface. Therefore, if the AssngVMAC option is issued with the Stop Assist Subcommand then the entire IP interface must be “stopped” (stop assist for ARP or stop assist for IPv6). This subcommand is functionally equivalent to terminating each IP protocol interface, e.g., Stop Assist for ARP (IPv4) and stop Assist (IPv6).

If the protocol interface (IPv4 or IPv6) is terminated with stop assist for ARP or IPv6 and is recovered with start assist, then the virtual MAC address may be re-assigned after the start ARP or start IPv6. Also, if the stop assist subcommand is issued for AssngVMAC, then the IP protocol interface is also logically terminated e.g., all registered IP addresses are invalidated just as if Stop ARP or Stop IPv6 were issued. The interface may then be recovered, e.g., using stop and start assist for ARP or IPv6.

The architecture may define Stop Assist for AssngVMAC as a valid subcommand. However, Stop Assist may not be implemented by the operating system. Instead, the operating system may issue Stop Assist for the applicable interface, e.g., ARP or IPv6.

Assignment Failures—An attempt to assign a layer 3 virtual MAC address that is rejected by network adapter or other process may be considered a “fatal or serious failure”. This error may be either a result of a network configuration error or a sequence error such as a “should not occur error” by the operating system. In either case, if this error occurs, the IP interface must be stopped and re-started, e.g., stop assist and start assist for ARP or IPv6. Recovery from such an error may be delegated to the operating system.

As noted above, each logical interface may be restricted to a single virtual MAC for IPv4 and a single virtual MAC for IPv6. Alternatively, to support virtual devices, e.g., virtual switches, etc., that may support many host connections over the same OSA connection, a connection may be configured so as to not be restricted to a single MAC for all IP address associated with the connection.

Virtual MAC Address Router

According to an aspect of the present invention, a “router” MAC address may be assigned in addition to assigning a virtual MAC address for logical interfaces, e.g., stacks per device, which may be deployed for all source IP address that have not been assigned a virtual MAC address. This approach supports a router host that is connected to a guest port on a Virtual Switch. The assignment of a router MAC address may further negate the use of the current primary/secondary router settings and may avoid eventual loss of inbound data for the un-registered IP address.

The Virtual Switch, as part of layer 3 VLAN trunk support, issues a gratuitous ARP for each IP-VLAN pair this is currently active on the switch. This is accomplished through the SEND_GRAT_ARP primitive. This process does not require modification other than to use the virtual MAC that has been assigned to the IP address and not the network adapter MAC address. To provide the ability for the Virtual Switch to assign a virtual MAC to a given IP address and support multiple IP/virtual MAC address pairs the SETIP primitive may be enhanced to accept a 6 byte MAC address.

SETIP

The SETIP command associates a specific IP address and optionally a Virtual MAC address to a specific TCP/IP user connection with a particular LAN adapter. For example, an adapter such as OSA-E associates the individual sessions with the tokens used to establish the MPC or QDIO connection. When receiving frames from the LAN, the device driver on the OSA-E card must be able to correlate the IP address in the IP datagram to the proper IP user session so the correct token can be specified when routing received packets to TCP/IP instances on the server. The SETIP command is used to establish this correlation.

The ability to designate a virtual router MAC to be deployed in support of a router virtual machine that is connected to the Virtual Switch may be provided by an enhanced version of the SETRTG command. Conceptually this is synonymous to its current purpose, i.e., designation of primary and secondary routers. The use of this command will be for the specification of a source MAC address for all IP addresses of a given L3 connection, that have not been assigned a MAC address. This construct will insure that IP addresses residing in a different subnet being serviced by a router virtual machine will be correctly routed to the Virtual Switch.

SETRTG

The purpose of the SETRTG command is to associate a specific IP instance as a primary, secondary, multicast or MAC routing node. A new flag (0x04) may be added to the SETRTG command with this support. This flag indicates that the request contains a full 6 byte MAC address and that is to be used as the source MAC address when constructing Ethernet frames for a source IP addresses that have not been assigned a virtual MAC.

Layer 3 virtual MAC address capability according to various aspects of the present invention may be utilized to provide virtual MAC per stack (per interface) consideration. Therefore, processes capable of utilizing a protocol stack are not required to share MAC addresses. Thus, for example, operating system images or stacks in a virtual environment are not required to share ports. As such, the layer 3 virtual MAC address support lends itself to a ready and intuitive configuration from both a load-balancer and a server node point of view. For example, external load balancers may use MAC level forwarding, e.g., operate in dispatch mode, into a set of virtual server nodes, e.g., the logical partitions 118 illustrated in FIGS. 2 and 3 that share the same physical network adapter 112.

Layer 3 virtual MAC address capability according to various aspects of the present invention removes dependency upon routing technologies that are not universally supported, such as NAT and GRE tunneling. For example, NAT technology in a load balancer imposes restrictions on use of network security technologies such as IPSec, thus limiting certain capabilities, e.g., the use of certain virtual private network (VPN) capability. Moreover, NAT may prevent the server node from knowing the real client IP address in some configurations, which would impact the ability to use general networking policies on the server nodes. Similarly, GRE Tunnels are not universally supported by load balancers and is not supported in an IPv6 environment.

Layer 3 virtual MAC address capability according to various aspects of the present invention improves outbound routing. For example, layer 3 virtual MAC address capability doesn't rely on having outbound traffic from the load-balanced servers routed via the load balancer. Comparatively, with conventional NAT-based load balancing technologies, all outbound IP packets from the load-balanced servers must be routed back via the load balancer, which in most cases adds an additional routing hop.

Layer 3 virtual MAC address capability according to various aspects of the present invention further simplifies the creation of a heterogeneous server environment where all server nodes behave according to commonly understood and agreed-to standards. For example, layer 3 virtual MAC address capability further provides improved port sharing and virtualization models, thus enabling future solutions which might otherwise be previously limited due to the single MAC address limitation. For example, virtual server nodes look and behave like ‘traditional’ server nodes on other platforms.

Layer 3 virtual MAC address capability according to various aspects of the present invention further allow operating systems to use a “standard” interface ID for IPv6 addresses. This allows the same auto-configured IPv6 addresses to be assigned to a stack, thus avoiding the use of non-standard interface IDs that may change when a stack is recycled.

Various aspects of the present invention further allow the network adapter to select the stack to forward the packet to the appropriate destination stack based upon a virtual local area network address ID and its corresponding virtual MAC address, thus avoiding complicated routing functions provided by the operating system that are designed to perform address resolution to different logical partitions within a processing device.

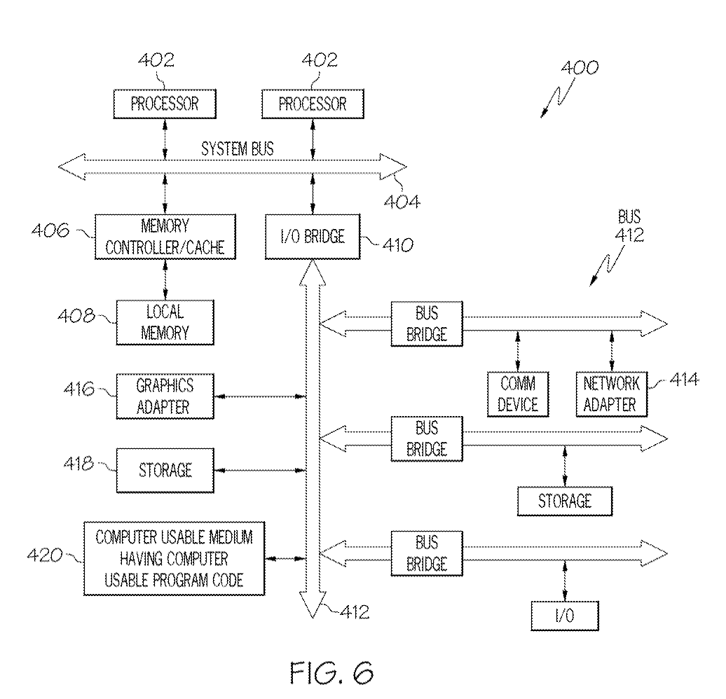

Referring to FIG. 6, a block diagram of a data processing system is depicted in accordance with the present invention. Data processing system 400 may comprise a symmetric multiprocessor (SMP) system or other configuration including a plurality of processors 402 connected to system bus 404. Alternatively, a single processor 402 may be employed. Also connected to system bus 404 is memory controller/cache 406, which provides an interface to local memory 408. An I/O bus bridge 410 is connected to the system bus 404 and provides an interface to an I/O bus 412. The I/O bus may be utilized to support one or more network adapters 414, as well as optionally, one or more busses and corresponding devices, such as bus bridges, input output devices (I/O devices), storage, etc.

Also connected to the I/O bus may be devices such as a graphics adapter 416, storage 418 and a computer usable medium 420 having computer usable program code embodied thereon. The computer usable program code may be utilized, for example, to implement the method 200 of FIG. 4, the method 300 of FIG. 5, and/or other features and aspects of the various aspects of the present invention as described more fully herein.

The data processing system depicted in FIG. 6 may be, for example, an IBM RS/6000 system, a product of International Business Machines Corporation in Armonk, N.Y., running the Advanced Interactive Executive (AIX) operating system. An object oriented programming system such as Java may run in conjunction with the operating system and provides calls to the operating system from Java programs or applications executing on data processing system.

The various aspects of the present invention may be embodied as systems, computer-implemented methods and computer program products. Also, various aspects of the present invention may take the form of an entirely hardware embodiment, an entirely software embodiment (including software, firmware, micro-code, etc.) or an embodiment combining software and hardware, wherein the embodiment or aspects thereof may be generally referred to as a “circuit,” “component” or “system.” Furthermore, the various aspects of the present invention may take the form of a computer program product on a computer-usable storage medium having computer-usable program code embodied in the medium or a computer program product accessible from a computer-usable or computer-readable medium providing program code for use by or in connection with a computer or any instruction execution system.

The software aspects of the present invention may be stored, implemented and/or distributed on any suitable computer usable or computer readable medium(s). For the purposes of this description, a computer-usable or computer readable medium can be any apparatus that can contain, store, communicate, propagate, or transport the program for use by or in connection with the instruction execution system, apparatus, or device. The computer program product aspects of the present invention may have computer usable or computer readable program code portions thereof, which are stored together or distributed, either spatially or temporally across one or more devices. A computer-usable or computer-readable medium may comprise, for example, an electronic, magnetic, optical, electromagnetic, infrared, or semiconductor system, apparatus, device, or propagation medium. As yet further examples, a computer usable or computer readable medium may comprise cache or other memory in a network processing device or group of networked processing devices such that one or more processing devices stores at least a portion of the computer program product. The computer-usable or computer-readable medium may also comprise a computer network itself as the computer program product moves from buffer to buffer propagating through the network. As such, any physical memory associated with part of a network or network component can constitute a computer readable medium.

More specific examples of the computer usable or computer readable medium comprise for example, a semiconductor or solid state memory, magnetic tape, an electrical connection having one or more wires, a swappable intermediate storage medium such as floppy drive or other removable computer diskette, tape drive, external hard drive, a portable computer diskette, a hard disk, a rigid magnetic disk, a random access memory (RAM), a read-only memory (ROM), an erasable programmable read-only memory (EPROM or Flash memory), a portable compact disc read-only memory (CD-ROM), a read/write (CD-R/W) or digital video disk (DVD), an optical fiber, disk or storage device, or a transmission media such as those supporting the Internet or an intranet. The computer-usable or computer-readable medium may also comprise paper or another suitable medium upon which the program is printed or otherwise encoded, as the program can be captured, for example, via optical scanning of the program on the paper or other medium, then compiled, interpreted, or otherwise processed in a suitable manner, if necessary, and then stored in a computer memory. The computer-usable medium may include a propagated data signal with the computer-usable program code embodied therewith, either in baseband or as part of a carrier wave or a carrier signal. The computer usable program code may also be transmitted using any appropriate medium, including but not limited to the Internet, wire line, wireless, optical fiber cable, RF, etc.

A data processing system suitable for storing and/or executing program code may include at least one processor coupled directly or indirectly to memory elements, e.g., through a system bus or other suitable connection. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any suitable language, including for example, an object oriented programming language such as Java, Smalltalk, C++ or the like. The computer program code for carrying out operations of the present invention may also be written in conventional procedural programming languages, such as the “C” programming language, or in higher or lower level programming languages. The program code may execute entirely on a single processing device, partly on one or more different processing devices, as a stand-alone software package or as part of a larger system, partly on a local processing device and partly on a remote processing device or entirely on the remote processing device. In the latter scenario, the remote processing device may be connected to the local processing device through a network such as a local area network (LAN) or a wide area network (WAN), or the connection may be made to an external processing device, for example, through the Internet using an Internet Service Provider.

The present invention is described with reference to flowchart illustrations and/or block diagrams of methods, apparatus systems and computer program products according to embodiments of the invention. It will be understood that each block of the flowchart illustrations and/or block diagrams, and combinations of blocks in the flowchart illustrations and/or block diagrams may be implemented by system components or computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention may be practiced on any form of computer system, including a stand alone computer or one or more processors participating on a distributed network of computers. Thus, computer systems programmed with instructions embodying the methods and/or systems disclosed herein, or computer systems programmed to perform various aspects of the present invention and storage or storing media that store computer readable instructions for converting a general purpose computer into a system based upon the various aspects of the present invention disclosed herein, are also considered to be within the scope of the present invention. Once a computer is programmed to implement the various aspects of the present invention, including the methods of use as set out herein, such computer in effect, becomes a special purpose computer particular to the methods and program structures of this invention. The techniques necessary for this are well known to those skilled in the art of computer systems.

The flowchart and block diagrams in the Figures illustrate the architecture, functionality, and operation of possible implementations of systems, methods and computer program products according to various embodiments of the present invention. In this regard, one or more blocks in the flowchart or block diagrams may represent a component, segment, or portion of code, which comprises one or more executable instructions for implementing the specified logical function(s). In some alternative implementations, the functions noted in the blocks may occur out of the order noted in the figures. For example, two blocks shown in succession may, in fact, be executed substantially concurrently or in the reverse order.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

Having thus described the invention of the present application in detail and by reference to embodiments thereof, it will be apparent that modifications and variations are possible without departing from the scope of the invention defined in the appended claims.

What is claimed is:

1. A method of combining layer 2 and layer 3 routing functions into a single logical functional layer by performing inbound routing of packets received by a physical network adapter of a processing device comprising:
evaluating an inbound frame to determine if an inbound frame destination MAC address is associated with said processing device;
determining whether said inbound frame should be routed to a corresponding logical interface or to drop said inbound frame if said inbound frame destination MAC address is equal to a virtual MAC address supported by said processing device; and
performing any necessary layer 3 functions and routing said inbound frame to said corresponding logical interface if it is determined that said inbound frame should be routed to said corresponding logical interface, thereby combining both layer 2 and layer 3 routing into a single logical function.

2. The method according to claim 1, wherein said evaluating an inbound frame to determine if an inbound frame destination MAC address is associated with said processing device comprises:
determining if said inbound frame destination MAC address is equal to said virtual MAC address.

3. The method according to claim 1, wherein said determining whether said inbound frame should be routed to a corresponding logical interface or to drop said inbound frame if said inbound frame destination MAC address is equal to said virtual MAC address comprises:
deciding to drop said inbound frame if said inbound frame contains a non-registered virtual local area network identification.

4. The method according to claim 1, wherein said determining whether said inbound frame should be routed to a corresponding logical interface or to drop said inbound frame if said inbound frame destination MAC address is equal to said virtual MAC address comprises:
deciding to route said inbound frame to said logical interface if said inbound frame either does not contain a virtual local area network identification or if said inbound frame contains a registered virtual local area network identification, regardless of a destination address in said inbound packet.

5. The method according to claim 1, wherein said determining whether said inbound frame should be routed to a corresponding logical interface or to drop said inbound frame if said inbound frame destination MAC address is equal to said virtual MAC address comprises:
deciding to route said inbound frame to said logical interface if:
said inbound frame contains a registered destination address; and
said inbound frame either does not contain a virtual local area network identification or said inbound frame contains a registered virtual local area network identification, regardless of a destination address in said inbound packet.

6. The method according to claim 1, wherein said evaluating an inbound frame to determine if an inbound frame destination MAC address is associated with said processing device comprises:
determining if said inbound frame destination MAC address is equal to a physical network adapter MAC address;
deciding to drop said inbound frame if said inbound frame contains a non-registered virtual local area network identification; and
deciding to route said inbound packet if a destination address in said inbound frame is registered and at said inbound frame either has no virtual local area network identification or a registered virtual local area network identification.

7. The method according to claim 1, further comprising:
dynamically assigning virtual MAC addresses to logical interfaces prior to receiving said inbound frame.

8. A computer program product to combine layer 2 and layer 3 routing functions into a single logical functional layer by performing inbound routing of packets received by a physical network adapter of a processing device comprising:
a computer usable medium having computer usable program code embodied therewith, the computer usable program code comprising:
computer usable program code configured to evaluate an inbound frame to determine if an inbound frame destination MAC address is associated with said processing device;
computer usable program code configured to determine whether said inbound frame should be routed to a corresponding logical interface or to drop said inbound frame if said inbound frame destination MAC address is equal to a virtual MAC address supported by said processing device; and
computer usable program code configured to perform any necessary layer 3 functions and route said inbound frame to said corresponding logical interface if it is determined that said inbound frame should be routed to said corresponding logical interface, thereby combining both layer 2 and layer 3 routing into a single logical function.

9. The computer program product according to claim 8, wherein said computer usable program code configured to evaluate an inbound frame to determine if an inbound frame destination MAC address is associated with said processing device comprises:
computer usable program code configured to determine if said inbound frame destination MAC address is equal to said virtual MAC address.

10. The computer program product according to claim 8, wherein said computer usable program code configured to determine whether said inbound frame should be routed to a corresponding logical interface or to drop said inbound frame if said inbound frame destination MAC address is equal to a virtual MAC address supported by said processing device comprises:
computer usable program code configured to decide to drop said inbound frame if said inbound frame contains a non-registered virtual local area network identification.

11. The computer program product according to claim 8, wherein said computer usable program code configured to determine whether said inbound frame should be routed to a corresponding logical interface or to drop said inbound frame if said inbound frame destination MAC address is equal to a virtual MAC address supported by said processing device comprises:
computer usable program code configured to decide to route said inbound frame to said logical interface if said inbound frame either does not contain a virtual local area network identification or if said inbound frame contains a registered virtual local area network identification, regardless of a destination address in said inbound packet.

12. The computer program product according to claim 8, wherein said computer usable program code configured to determine whether said inbound frame should be routed to a corresponding logical interface or to drop said inbound frame if said inbound frame destination MAC address is equal to a virtual MAC address supported by said processing device comprises:
computer usable program code configured to decide to route said inbound frame to said logical interface if:
said inbound frame contains a registered destination address; and
said inbound frame either does not contain a virtual local area network identification or said inbound frame contains a registered virtual local area network identification, regardless of a destination address in said inbound packet.

13. The computer program product according to claim 12, wherein said computer usable program code configured to evaluate an inbound frame to determine if an inbound frame destination MAC address is associated with said processing device comprises:
computer usable program code configured to determine if said inbound frame destination MAC address is equal to a physical network adapter MAC address;
computer usable program code configured to decide to drop said inbound frame if said inbound frame contains a non-registered virtual local area network identification; and
computer usable program code configured to decide to route said inbound packet if a destination address in said inbound frame is registered and at said inbound frame either has no virtual local area network identification or a registered virtual local area network identification.

14. The computer program product according to claim 8, further comprising:
computer usable program code configured to dynamically assign virtual MAC addresses to logical interfaces prior to receiving said inbound frame.

15. A computer processing system that supports multiple virtual servers by combining layer 2 and layer 3 routing functions into a single logical functional layer comprising:
a physical network adapter that performs inbound routing of packets received from a network communication that is configured to:
evaluate an inbound frame to determine if an inbound frame destination MAC address is associated with said processing device;
determine whether said inbound frame should be routed to a corresponding logical interface or to drop said inbound frame if said inbound frame destination MAC address is equal to a virtual MAC address supported by said processing device; and
perform any necessary layer 3 functions and route said inbound frame to said corresponding logical interface if it is determined that said inbound frame should be routed to said corresponding logical interface, thereby combining both layer 2 and layer 3 routing into a single logical function.

16. The computer processing system according to claim 15, wherein said physical network adapter is further configured to determine if said inbound frame destination MAC address is equal to said virtual MAC address.

17. The computer processing system according to claim 15, wherein said physical network adapter is further configured decide to drop said inbound frame if said inbound frame contains a non-registered virtual local area network identification.

18. The computer processing system according to claim 15, wherein said physical network adapter is further configured to route said inbound frame to said logical interface if said inbound frame either does not contain a virtual local area network identification or if said inbound frame contains a registered virtual local area network identification, regardless of a destination address in said inbound packet.

19. The computer processing system according to claim 15, wherein said physical network adapter is further configured to decide to route said inbound frame to said logical interface if:
said inbound frame contains a registered destination address; and
said inbound frame either does not contain a virtual local area network identification or said inbound frame contains a registered virtual local area network identification, regardless of a destination address in said inbound packet.

20. The computer processing system according to claim 19, wherein said physical network adapter is further configured to:
determine if said inbound frame destination MAC address is equal to a physical network adapter MAC address;
drop said inbound frame if said inbound frame contains a non-registered virtual local area network identification; and
route said inbound packet if a destination address in said inbound frame is registered and at said inbound frame either has no virtual local area network identification or a registered virtual local area network identification.

21. The computer processing system according to claim 15, wherein said physical network adapter is further configured to dynamically assign virtual MAC addresses to logical interfaces prior to receiving said inbound frame.
